(19) United States
(12) Patent Application Publication
(10) Pub. No.: US 2010/0127099 A1
(43) Pub. Date: May 27, 2010

(54) Sprinkler head protective cover

(76) Inventor: Ralph Memole, Hollywood, FL (US)

Correspondence Address: GrayRobinson, P. A., 401 E. LAS OLAS BLVD, SUITE 1850, FORT LAUDERDALE, FL, 33301, US

(21) Appl. No.: 12/313,754

(22) Filed: Nov. 24, 2008

(51) Int. Cl. B05B 15/00

(52) U.S. Cl. 239/288.3

(57) ABSTRACT

An apparatus for retaining an in-ground pop-up sprinkler head in position, and protecting same, comprising a top member adapted to be placed substantially coplanar with the top of a conventional pop-up sprinkler head, a cylindrical sidewall depending generally vertically from an underside of the plate, the cylindrical sidewall defining internal threads thereon adapted to co-act with corresponding external threads on a cylindrical collar. In use, the collar and plate are placed in sandwiching engagement about a sprinkler head top, and the collar is threaded onto the sidewall to lock the sprinkler head in position relative to the apparatus. The sprinkler head can then be attached to a water supply conduit in any one of a number of interconnection arrangements.

### BACKGROUND OF THE INVENTION

1. Field of the Invention

This invention relates generally to protective covers, and relates more particularly to a ground-engaging guard for any type of pop-up sprinkler heads.

2. Background Art

In-ground pop-up sprinkler heads are widely used to irrigate plants throughout the world. Typically, a significant investment is made in the installation of in-ground irrigation conduit and associated in-ground sprinkler heads. These sprinkler heads attach, usually as by threading, to vertically extending terminal ends of the irrigation conduit such that the top portion of the pop-up sprinkler head is substantially flush with the adjacent ground level. It is essential to retain the sprinkler head in the installed orientation (e.g. vertical) so that the irrigation provided by the sprinkler head will be uniform and cover the intended area.

Also, due to the exposed nature of in-ground sprinkler heads, they are easily damaged by lawn equipment being driven over them, foot traffic and the like. Numerous attempts at providing protection for in-ground sprinkler heads have been made. The following U.S. patents disclose various of these attempts:

None of these patents, however, disclose a sprinkler head positioning, stabilizing and protective cover which does not threadingly engage the sprinkler head or water conduit, but which sandwiches the top of the sprinkler head between a collar and protective upper disc which threadingly connect to each other prior to threadingly engaging the sprinkler head onto the water conduit.

It is a principal object of this invention to provide a position stabilizer for in-ground pop-up sprinkler heads.

It is also an object of this invention to provide a protective guard or cover for in-ground pop-up sprinkler heads.

It is a further object of this invention to provide a protective guard for in-ground pop-up sprinkler heads to preserve the life thereof so as to decrease the incidents of damage to the sprinkler heads protected thereby.

### BRIEF DESCRIPTION OF THE DRAWINGS

FIG. 1 is a perspective exploded view of the preferred embodiment of the invention.

FIG. 2 is a cross-sectional elevational view of the invention installed about a pop-up sprinkler head in the ground.

FIG. 3 is a top plan view of the disc 12 of the preferred embodiment of this invention

FIG. 4 is a side cross-sectional elevational view of the disc of this invention, incorporating a retention ring to permit use of very small pop-up sprinkler heads with the invention.

### DETAILED DESCRIPTION OF PREFERRED EMBODIMENT(S)

Referring now to the drawings, the preferred embodiment of the invention comprises a ground-engaging protective/stabilizing disc or plate 12 which defines a concentrically disposed central aperture 14 and a depending cylindrical sidewall 16 concentric with aperture 14, sidewall 16 defining internal threads 18 on at least a portion of its inner surface, and an annular collar 20 defining threads 22 on at least a portion of its external peripheral surface. The inside diameter of threads 18 are nearly the same as the outside diameter of threads 22 on collar 20 so that collar 20 can be threaded onto cylindrical sidewall 16 in a manner to become apparent hereinafter.

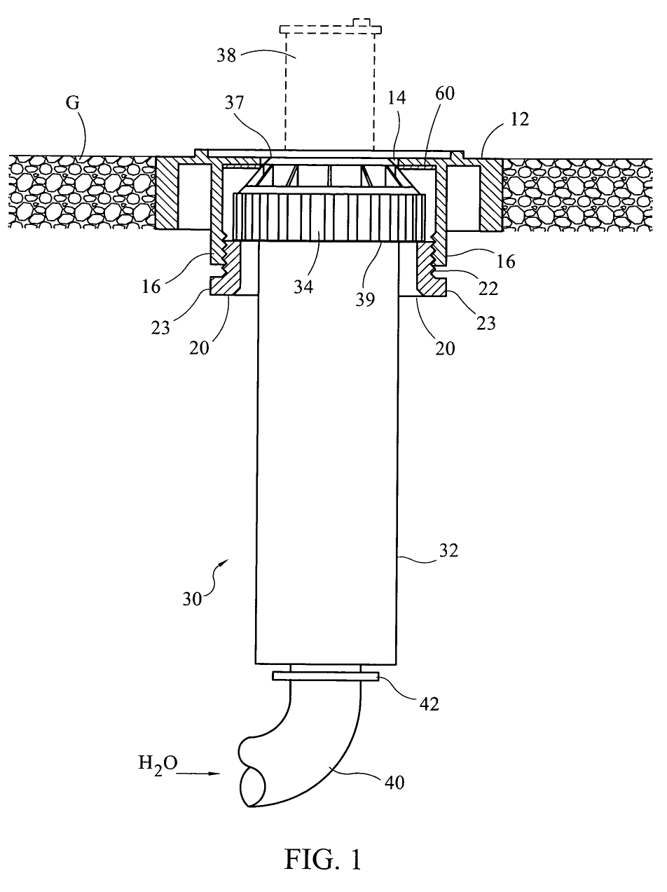

The invention is adapted to be used with a conventional in-ground pop-up sprinkler head 30, which are manufactured in a variety of configurations, each of which is intended to be suitable for use with this invention. A typical pop-up sprinkler head suitable for use with this invention is comprised of a generally cylindrical main body portion 32, a sprinkler head top portion 34 threadingly or otherwise engaged upon main body 32. A centrally located aperture 37 in sprinkler head top 34 permits the pop-up dispenser nozzle and tube 38 to reciprocate between a retracted position, wherein it is essentially flush with the top of sprinkler head top 34, and a second, deployed position, shown in phantom in FIG. 1. Sprinkler head top defines an outer peripheral edge section 35, which may or may not be tapered, and is adapted to be placed in registry with aperture 14 of disc 12.

To utilize the invention, a hole is dug in the ground adjacent a pressurized water supply conduit 40, which conduit typically is threaded or otherwise adapted to receive a corresponding fitting 42 at or near the bottom of sprinkler head 30 in a manner which will occur to those of skill in the art. Collar 20 is then slid up the outside of main body 32 until its upper surface 24 contacts the shoulder 39 created by the intersection of main body 32 and sprinkler head top 34. Then, disc 12 and collar 20 are threaded together so as to sandwich sprinkler head top 34 between the area of disc 12 adjacent aperture 14 and upper surface 24 of collar 20. Thereafter, sprinkler head 30 can be threaded or glued onto water supply conduit 40 in such a way that disc 12 is positioned essentially at the level of ground G. Disc 12 and sprinkler head 30 are, thereby, held in position by the tensile strength of water supply conduit 40.

When installed, sprinkler head 30 is both positioned fairly rigidly in the location designated by the installer and substantially protected against impacts from objects moving over the ground such as vehicles, people, edgers, weed whackers, etc.

Preferably, but not by way of limitation, collar 20 includes a series of protrusions 23 around a portion of the outer periphery thereof to assist in the threading of collar 20 onto disc sidewall 16. The user merely engages projections 23 to assist with exerting the necessary force on collar 20 to cause it to firmly engage shoulder 39 and urge the peripheral edge 35 of sprinkler head top 34 into engagement with area surrounding aperture 14 in disc 12.

Likewise, similar protrusions 15 may be disposed in disc 12 to facilitate the threading of sprinkler head 30 onto water supply conduit 40 once the sprinkler head and guard of this invention are assembled, the installer merely grasps disc 12 near its outer periphery, engages protrusions 15 with his or her fingers, and threads or glues sprinkler head 30 onto water supply conduit 40. Thereafter, the hole in ground G is back filled so as to retain sprinkler head 30 in place.

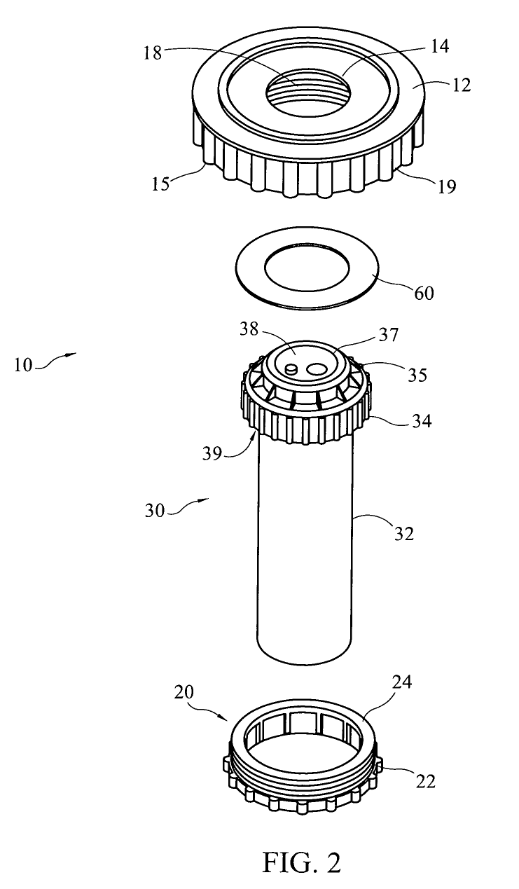

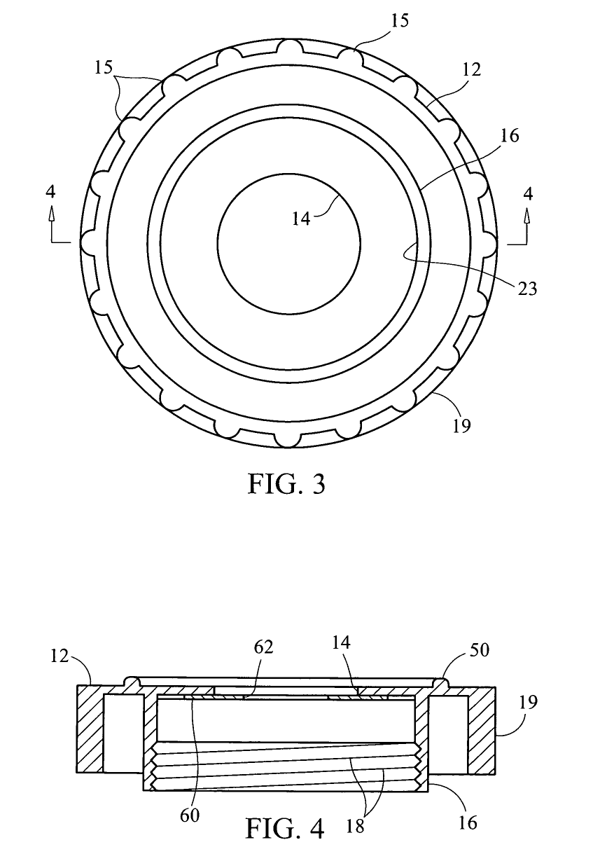

Also, preferably, but not by way of limitation, one or more ribs 50 may be included with disc 12 to provide additional resistance to potentially destructive impact by external objects. Rib or ribs 50 may be concentrically disposed as shown in FIG. 2, may be longitudinal, diametric, radial, or in any other orientation.

Disc 12 may be manufactured of any suitable material, such as high impact plastic, aluminum, stainless steel, cast iron or the like. If made of plastic, it may be impregnated with phosphorescent material to glow in the dark so that the disc 12 is visible in the dark to prevent it being stepped upon.

Additionally, as shown in FIG. 4, for pop-up sprinkler heads having sprinkler head tops 34 which are smaller than the inside diameter of aperture 14, a retaining washer 60 or the like may be employed defining an aperture 62 which is smaller than the outside diameter of sprinkler head top 34. To install the apparatus of this invention on a sprinkler head having a sprinkler head top 34 which is smaller than aperture 14, merely place disc 60 in concentric registry with aperture 14, place sprinkler head top 34 against washer 60, thread collar 20 onto threaded internal surface of sidewall 16 until circumferential area 35 abuts the area adjacent aperture 62 (as seen in FIG. 4), and install the sprinkler head 30 upon water supply conduit 40.

It is to be understood that threads 18, 22 associated with sidewall 16 and collar 20, respectively, are but an example of an arrangement to interconnect disc 12 and collar 20. Alternatively, snap-fit or twist-lock arrangements are also contemplated as will occur to those of skill in the art. Also, adhesively interconnecting collar 20 to sidewall 16 is also contemplated as being within the scope of this invention, although less preferable as to separate the two from each other it is likely that some damage to the apparatus may occur. Any other arrangement for connecting collar 20 to sidewall 16 is contemplated to be within the scope of this invention.

The shape of the sprinkler head top 34 shown in the drawings is representative. Any of the commercially available sprinkler heads on the market will function with this invention. All that is required is for the central aperture 14 to have a smaller diameter than the diameter of the sprinkler head top 34, and for the dispenser nozzle and tube 38 to have a diameter which is smaller than the diameter of central aperture 14.

Various modifications and alterations of this invention will become apparent to those skilled in the art without departing from the scope and spirit of this invention, and it is understood that this invention is not limited to the illustrative embodiments set forth hereinbefore.

What is claimed:

1. A sprinkler head guard adapted to partially cover an in-ground sprinkler head, the sprinkler head being of the type having:
a cylindrical main body terminating at an upper peripheral edge with a partial threaded exterior wall;
a sprinkler head top defining an interiorly threaded wall adapted to engage the threads of the exterior threaded wall of the main body, the main body having an outer diameter which is less than an outer diameter of the sprinkler head top, such that a downwardly facing shoulder is formed by the sprinkler head top when the sprinkler head top is threaded upon the main body portion, the sprinkler head top defining an upper surface terminating at an upper peripheral edge, the sprinkler head further including a pop-up discharge nozzle adapted to dispense irrigation water when water under pressure is delivered to the pop-up discharge nozzle, the guard comprising:
a disc defining a central circular opening through which is adapted to pass the pop-up discharge nozzle when the sprinkler head top is positioned in registry with the circular opening of the disc, the disc extending outwardly substantially horizontally and defining a downwardly facing surface adapted to engage the ground;
the disc further comprising a downwardly extending cylindrical substantially vertical wall defining threads on an inner surface thereof;
a cylindrical collar having an outer threaded surface adapted to engage the threads of the cylindrical wall of the disc, the collar defining an upper surface adapted to engage the shoulder when the threads of the collar are engaged upon the threads of the cylindrical wall of the disc;
the central circular opening of the disc being defined by a circular peripheral edge substantially centrally located on the disc, the circular peripheral edge adapted to engage the upper surface of the sprinkler head top when the collar is engaged against the shoulder to retain the disc in position relative to the pop-up sprinkler head.

2. The sprinkler head guard of claims 1, further including a retaining washer adapted to be positioned substantially in registry with the central circular opening of the disc, the retaining washer defining a central circular opening, the central circular opening of the retaining washer being smaller than the central circular opening of the disc.

3. The guard of claim 2, wherein the disc and collar are manufactured from a material selected from the group of high impact plastic, aluminum, stainless steel or cast iron.

4. The guard of claim 1, wherein the disc and collar are manufactured of a phosphorescent material.

5. The guard of claim 1, further including a rib associated with an upper facing surface of the disc.

6. The guard of claim 5, wherein the rib is concentric with the central circular opening of the disc.

7. The guard of claim 1, wherein the rib extends diametrically across an upper surface of the disc.
